(19) United States
(12) Patent Application Publication
(10) Pub. No.: US 2025/0024495 A1
(43) Pub. Date: Jan. 16, 2025

(54) METHOD FOR RESOURCE ALLOCATION ON SHARED SPECTRUM AND DEVICE THEREOF

(71) Applicant: ZTE CORPORATION, Shenzhen (CN)

(72) Inventors: Wei LUO, Shenzhen (CN); Weiqiang DU, Shenzhen (CN); Lin CHEN, Shenzhen (CN)

(73) Assignee: ZTE CORPORATION, Shenzhen (CN)

(21) Appl. No.: 18/900,019

(22) Filed: Sep. 27, 2024

Related U.S. Application Data
(63) Continuation of application No. PCT/CN2022/130064, filed on Nov. 4, 2022.

(51) Int. Cl. H04W 74/0808; H04W 28/02; H04W 72/563

(52) U.S. Cl. CPC H04W 74/0808; H04W 28/0268; H04W 72/563

(57) ABSTRACT

A wireless communication method for use in a wireless terminal is disclosed. The method comprises determining a sidelink channel access priority for a sidelink transmission in an unlicensed carrier based on a channel access priority class value, and performing a listen-before-talk (LBT) procedure in the unlicensed carrier for the sidelink transmission based on the sidelink channel access priority, wherein the channel access priority class value is selected from a plurality of channel access priority class values associated with a plurality of quality of service (QoS) files of the sidelink transmission.

### CROSS-REFERENCE TO RELATED APPLICATION

This application claims the benefit of priority under 35 U.S.C. § 120 as a continuation of International Patent Application No. PCT/CN2022/130064, filed on Nov. 4, 2022, the disclosure of which is incorporated herein by reference in its entirety.

### TECHNICAL FIELD

This document is directed generally to wireless communications, in particular to 5th generation wireless communications, and in more particular to sidelink communications.

Generally speaking, wireless communications are performed with user terminal devices and base stations. In addition, wireless communications are performed on carriers or frequency bands. Some carriers are licensed carriers, which are carriers licensed by a governmental or other authoritative entities to a service provider for an exclusive use. On the other hand, other carriers are unlicensed carriers, which are carriers not licensed by such governmental or other authoritative entities. Currently, the user terminal devices may be able to communicate directly with each other (i.e., without use of a base station) on the licensed carriers. However, ways for the user terminal devices to communicate directly with each other on unlicensed carriers may be desirable.

### BACKGROUND

The present disclosure is directed to methods, systems, and devices related to wireless communications, and more specifically, to methods, systems, and devices related to providing resource allocation method for sidelink communications performing on an unlicensed carrier (e.g., shared spectrum).

### SUMMARY

The present disclosure relates to a wireless communication method for use in a wireless terminal. The method comprises:
determining a sidelink channel access priority for a sidelink transmission in an unlicensed carrier based on a channel access priority class value, and
performing a listen-before-talk (LBT) procedure in the unlicensed carrier for the sidelink transmission based on the sidelink channel access priority,
wherein the channel access priority class value is selected from a plurality of channel access priority class values associated with a plurality of quality of service (QOS) files of the sidelink transmission.

Various embodiments may preferably implement the following features:

Preferably or in some embodiments, the plurality of channel access priority class values is corresponding to a plurality of PC5 QoS identifier values or a plurality of packet delay budget values determined for the plurality of QoS files.

Preferably or in some embodiments, the selected channel access priority class value is the lowest or the highest channel access priority class value in the plurality of channel access priority class values.

Preferably or in some embodiments, the selected channel access priority class value is a default channel access priority class value for a QoS flow corresponding to a non-standardized PQI.

Preferably or in some embodiments, the non-standardized PQI has no corresponding channel access priority class value or is mapped to a default data radio bearer.

Preferably or in some embodiments, the default value is received from a wireless network node or preconfigured.

The present disclosure relates to wireless communication method for use in a wireless terminal, the method comprising:
performing an initial transmission or a retransmission for a sidelink transmission on a first configured sidelink grant.

Various embodiments may preferably implement the following features:

Preferably or in some embodiments, performing the initial transmission or the retransmission for the sidelink transmission on the first configured sidelink grant comprises:
performing the retransmission for the sidelink transmission on the first configured sidelink grant in response to at least one of:
the wireless terminal does not receive, from a wireless network node, a sidelink configuration for at least one physical uplink control channel resource; or
the wireless terminal receives, from a wireless network node, configuration information indicating that at least one resource associated with the first configured sidelink grant can be used for the retransmission for the sidelink transmission.

Preferably or in some embodiments, performing the initial transmission or the retransmission for the sidelink transmission on the first configured sidelink grant comprises:
performing the initial transmission for the sidelink transmission on the first configured sidelink grant in response to at least one of:
the wireless terminal receives, from a wireless network node, a sidelink configuration for at least one physical uplink control channel resource; or
the wireless terminal does not receive, from a wireless network node, configuration information indicating that at least one resource associated with the first configured sidelink grant can be used for the retransmission for the sidelink transmission, or
the wireless terminal receives, from a wireless network node, configuration information indicating that at least one resource associated with the first configured sidelink grant cannot be used for the retransmission for the sidelink transmission.

Preferably or in some embodiments, performing the initial transmission or the retransmission for the sidelink transmission on the first configured sidelink grant comprises:
performing the retransmission for the sidelink transmission on the first configured sidelink grant in response to at least one of:
the sidelink transmission is not performed on a previous dynamic sidelink grant because a listen-before-talk (LBT) failure is detected, or
the sidelink transmission is not performed on a previous configured sidelink grant because an LBT failure is detected, or
the sidelink transmission is performed on a previous configured sidelink grant for the associated hybrid automatic repeat request (HARQ) process and a media access control entity does not receive, from a layer entity lower than the media access control entity, an indication of an LBT failure, or
the associated HARQ process is pending, or
the configured sidelink grant capable of fulfilling a remaining PDB of retransmission data associated with the sidelink HARQ process, or
the configured sidelink grant can fulfils a latency requirement of a MAC CE if included.

Preferably or in some embodiments, the wireless communication method further comprises:
performing the sidelink transmission on a resource associated with a second configured sidelink grant, and
mapping a first HARQ process identifier associated with the first configured sidelink grant and a second HARQ process identifier associated with the second configured sidelink grant to a one sidelink process identifier of the sidelink transmission in a media access control entity.

The present disclosure relates to a wireless communication method for use in a media access control entity in a wireless terminal. The method comprises:
determining a sidelink hybrid automatic repeat request (HARQ) process status of a sidelink HARQ process for a configured sidelink grant.

Various embodiments may preferably implement the following features:

Preferably or in some embodiments,
in response to the sidelink HARQ process status being set as non-pending, or
in response to the sidelink HARQ process status being set as pending and the configured sidelink grant capable of fulfilling a remaining packet delay budget (PDB) of retransmission data associated with the sidelink HARQ process, or
in response to the sidelink HARQ process status being set as pending and the configured sidelink grant capable of fulfilling a latency requirement of a media access control (MAC) control element (CE) if included,
the method further comprises at least one of:
determining that a new data indicator for the corresponding sidelink HARQ process is toggled,
determining that a sidelink data transmission duration associated with the configured sidelink grant is used for initial transmission, or
flushing a HARQ buffer of the sidelink HARQ process.

Preferably or in some embodiments, a first timer is not running, wherein the first timer is configured to start or restart when a sidelink data transmission associated with the sidelink HARQ process is performed and is configured to stop in response to a reception of an acknowledgement message for the sidelink data transmission.

Preferably or in some embodiments, a first number of transmission times of a media access control protocol data unit transmitted in a sidelink data transmission associated with the sidelink HARQ process is greater than or equal to a first maximum transmission number.

Preferably or in some embodiments,
in response to that the sidelink HARQ process is pending, or
in response to that the sidelink HARQ process is pending and the configured sidelink grant capable of fulfilling a remaining PDB of retransmission data associated with the sidelink HARQ process, or
in response to that the sidelink HARQ process is pending and that the configured sidelink grant can fulfils a latency requirement of a MAC CE if included,
the method further comprises delivering, to a HARQ entity, the configured sidelink grant and HARQ information of the sidelink HARQ process.

Preferably or in some embodiments, the wireless communication method further comprises receiving, from the HARQ entity, an instruction of triggering a retransmission of a Sidelink transmission associated with the sidelink HARQ process.

Preferably or in some embodiments, a first number of transmission times of a media access control protocol data unit transmitted in a sidelink data transmission associated with the sidelink HARQ process is less than a first maximum transmission number.

Preferably or in some embodiments, the wireless communication method further comprises incrementing the first number of transmission times by 1 if the sidelink transmission is performed.

Preferably or in some embodiments, the wireless communication method further comprises incrementing the first number of transmission times by 1 if the sidelink transmission is performed and a listen-before-talk failure is not received or received from a layer entity lower than the media access control layer entity

Preferably or in some embodiments, the wireless communication method further comprises receiving, from a wireless network node or a peer wireless terminal of the sidelink data transmission, configuration information comprising at least one of a value of the first timer or the first maximum transmission number.

Preferably or in some embodiments, the received first maximum transmission number is associated to a channel access priority class value.

Preferably or in some embodiments, the sidelink HARQ process status is determined as non-pending in response to at least one of:
a transmission is performed on the sidelink HARQ process and that the media access control entity does not receive, from a layer entity lower than the media access control entity, an indication of a listen-before-talk failure; or
the HARQ buffer for this sidelink HARQ process is flushed.

Preferably or in some embodiments, the sidelink HARQ process status is determined as pending in response to that a transmission is performed on the sidelink HARQ process and that the media access control entity receives, from a layer entity lower than the media access control entity, an indication of a listen-before-talk failure.

Preferably or in some embodiments, a sidelink data transmission resource is not a 1^{st} sidelink data transmission resource configured by the configured sidelink grant in a period, wherein:
in response to that the sidelink HARQ process status is set as non-pending, or
in response to that the sidelink HARQ process status is set as pending and that the configured sidelink grant fulfils a remaining PDB of retransmission data associated with the sidelink HARQ process, or
in response to that the sidelink HARQ process status is set as pending and that the configured sidelink grant fulfils a latency requirement of a MAC CE if included, or
in response to that the sidelink HARQ process status is set as pending and that a first timer is not running, or
in response to that the sidelink HARQ process status is set as pending and that a first number of transmissions of the MAC PDU reaches a first maximum transmission number,
the method further comprises ignoring the configured sidelink grant.

Preferably or in some embodiments, the wireless communication method further comprises flushing a HARQ buffer of an associated sidelink HARQ process for the sidelink transmission.

The present disclosure relates to a wireless communication method for use in a wireless terminal. The method comprises:
receiving configuration information for a configurated sidelink grant, and
performing a sidelink transmission on the configured sidelink grant based on the configuration information.

Various embodiments may preferably implement the following features:

Preferably or in some embodiments, the configuration information comprises at least one of a value for a first timer, a value for a second timer or a second maximum transmission number.

Preferably or in some embodiments, the configuration information is received from a wireless network node or a peer wireless terminal of the sidelink data transmission.

Preferably or in some embodiments, the second maximum transmission number is associated with a channel access priority class value.

Preferably or in some embodiments, the network may or may not provide dynamic sidelink grant for sidelink retransmission, so the UE can be configured with a second timer. When the second timer is running, the UE may not be allowed to perform retransmission on some of resources associated with configured sidelink grant.

Preferably or in some embodiments,
in response to a first timer is not running, wherein the first timer is configured to start or restart when the sidelink communication is performed for a sidelink HARQ process corresponding to the sidelink communication and is configured to stop in response to a reception of an acknowledgement message for the sidelink data transmission, or
in response to the first timer is running and a second timer is not running, wherein the second timer is configured to start or restart after the sidelink data transmission is performed or after the corresponding PUCCH transmission carrying the SL HARQ feedback, or
in response to the configured sidelink grant cannot fulfil a remaining PDB of data of the sidelink transmission, or
in response to the configured sidelink grant cannot fulfil a latency requirement of a MAC CE if included, or
in response to a second number of transmission times of a MAC PDU in the sidelink transmission reaches a second maximum transmission number,
the method further comprises at least one of:
determining that a new data indicator for the sidelink HARQ process corresponding to the sidelink transmission is toggled,
determining that a sidelink data transmission duration associated with the configured sidelink grant is used for initial transmission, or
flushing an a HARQ buffer of the corresponding sidelink HARQ process.

Preferably or in some embodiments, the wireless communication method further comprises delivering, to a HARQ entity, the configured sidelink grant and HARQ information of the sidelink HARQ process.

Preferably or in some embodiments, a sidelink data transmission resource for the sidelink transmission is a 1^{st} sidelink data transmission resource or any sidelink data transmission resource configured by the configured sidelink grant in a period.

Preferably or in some embodiments,
in response to a first timer is not running, wherein the first timer is configured to start or restart when the sidelink communication is performed for a sidelink HARQ process corresponding to the sidelink communication and is configured to stop in response to a reception of an acknowledgement message for the sidelink data transmission, or
in response to the first timer is running and a second timer is not running, wherein the second timer is configured to start or restart after the sidelink data transmission is performed for the sidelink HARQ process after the corresponding PUCCH transmission carrying the SL HARQ feedback, or in response to the configured sidelink grant cannot fulfil a remaining PDB of data of the sidelink transmission, or
in response to the configured sidelink grant cannot fulfil a latency requirement of a MAC CE if included, or
in response to a second number of transmission times of a MAC PDU in the sidelink transmission reaches a second maximum transmission number,
the method further comprises ignoring the configured sidelink grant and/or flushing an a HARQ buffer of the corresponding sidelink HARQ process.

Preferably or in some embodiments, a sidelink data transmission resource for the sidelink transmission is any sidelink data transmission resource configured by the configured sidelink grant in a period other than a 1^{st} sidelink data transmission resource configured by the configured sidelink grant in the period.

Preferably or in some embodiments, the wireless communication method further comprises incrementing the second number of transmission times by 1 if the sidelink transmission is performed and a listen-before-talk failure is not received from a layer entity lower than a media access control entity

Preferably or in some embodiments, the wireless communication method further comprises incrementing the second number of transmission times by 1 if the sidelink transmission is performed.

The present disclosure relates to a wireless communication method for use in a wireless terminal. The method comprises:
selecting at least one sidelink resource from a configured resource pool, and
performing a sidelink transmission on the selected at least one sidelink resource,
wherein a number of retransmissions for a media access control protocol data unit in the sidelink transmission is less than a third sidelink maximum transmission number.

Various embodiments may preferably implement the following features:

Preferably or in some embodiments, the wireless communication method further comprises receiving, from a wireless network node, configuration information indicating the third sidelink maximum transmission number.

Preferably or in some embodiments, the third sidelink maximum transmission number is preconfigured.

Preferably or in some embodiments, the third sidelink maximum transmission number is associated with a channel access priority class value of the media access control protocol data unit.

The present disclosure relates to a wireless communication method for use in a first wireless terminal. The method comprises prioritizing a sidelink transmission on an unlicensed carrier over a transmission on a licensed carrier, wherein a resource on which the sidelink transmission is transmitted is associated with a resource set indicated by a channel occupancy time (COT).

Various embodiments may preferably implement the following features:

Preferably or in some embodiments, the wireless communication method further comprises receiving, from a second wireless terminal, information of the COT.

Preferably or in some embodiments, the wireless communication method further comprises generating the COT

Preferably or in some embodiments, the transmission on the licensed carrier is an uplink transmission.

Preferably or in some embodiments, the transmission is not prioritized by a layer entity higher than a physical layer entity in the first wireless terminal.

Preferably or in some embodiments, the layer entity higher than the physical layer entity comprises a Non-Access-Stratum layer entity.

The present disclosure relates to a wireless terminal. The wireless terminal comprises a processor, configured to:
determine a sidelink channel access priority for a sidelink transmission in an unlicensed carrier based on a channel access priority class value, and
perform a listen-before-talk (LBT) procedure in the unlicensed carrier for the sidelink transmission based on the sidelink channel access priority,
wherein the channel access priority class value is selected from a plurality of channel access priority class values associated with a plurality of quality of service (QOS) files of the sidelink transmission.

Various embodiments may preferably implement the following feature:

Preferably or in some embodiments, the processor is further configured to perform any of aforementioned wireless communication methods.

The present disclosure relates to a wireless terminal. The wireless terminal comprises:
a processor, configured to perform a new transmission or a retransmission for a sidelink transmission on a first configured sidelink grant.

Various embodiments may preferably implement the following feature:

Preferably or in some embodiments, the processor is further configured to perform any of aforementioned wireless communication methods.

The present disclosure relates to a wireless terminal. The wireless terminal comprises:
a processor, configured to determine a sidelink hybrid automatic repeat request (HARQ) process status of a sidelink HARQ process for a configured sidelink grant.

Various embodiments may preferably implement the following feature:

Preferably or in some embodiments, the processor is further configured to perform any of aforementioned wireless communication methods.

The present disclosure relates to a wireless terminal. The wireless terminal comprises:
a communication unit, configured to receive configuration information for a configurated sidelink grant, and
a processor, configured to perform a sidelink transmission on the configured sidelink grant based on the configuration information.

Various embodiments may preferably implement the following feature:

Preferably or in some embodiments, the processor is further configured to perform any of aforementioned wireless communication methods.

The present disclosure relates to a wireless terminal. The wireless terminal comprises:
a processor, configured to:
select at least one sidelink resource from a configured resource pool, and
perform a sidelink transmission on the selected at least one sidelink resource,
wherein a number of retransmissions for a media access control protocol data unit in the sidelink transmission is less than a third sidelink maximum transmission number.

Various embodiments may preferably implement the following feature:

Preferably or in some embodiments, the processor is further configured to perform any of aforementioned wireless communication methods.

The present disclosure relates to a first wireless terminal. The first wireless terminal comprises:
a processor, configured to prioritize a sidelink transmission on an unlicensed carrier over a transmission on a licensed carrier,
wherein a resource on which the sidelink transmission is transmitted is associated with a resource set indicated by a channel occupancy time (COT).

Various embodiments may preferably implement the following feature:

Preferably or in some embodiments, the processor is further configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a wireless communication system according to an embodiment of the present disclosure.

FIG. 2 shows a schematic diagram of a configuration of layer entities for a communication node according to an embodiment of the present disclosure.

FIG. 3 shows a flow chart of method for wireless communication that includes detecting for listen-before-talk (LBT) failures according to an embodiment of the present disclosure.

FIG. 4 shows a schematic diagram of sidelink communication according to an embodiment of the present disclosure.

FIGS. 5 to 10 show flowcharts of methods according to embodiments of the present disclosure.

### DETAILED DESCRIPTION

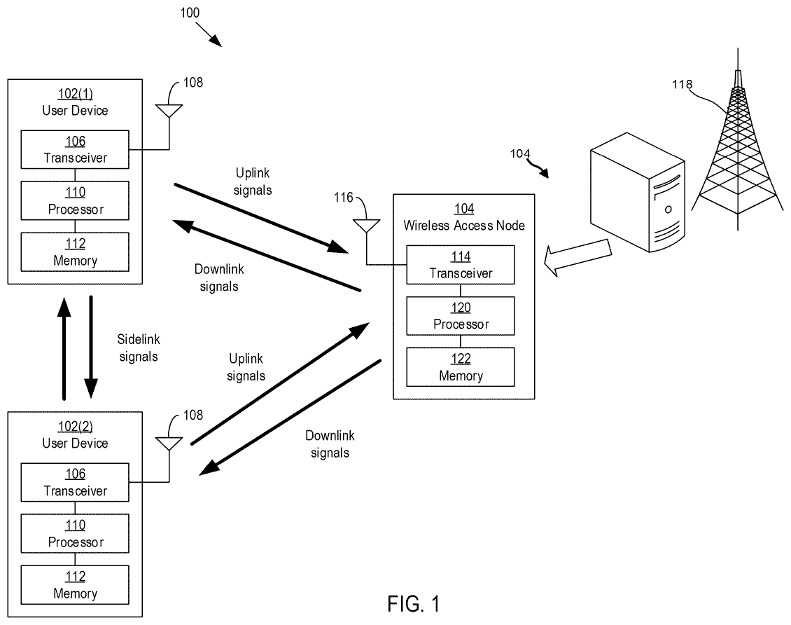

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of user devices 102 and wireless access nodes 104, including two or more user devices 102 without any wireless access nodes 104, only one user device 102 and only one wireless access node 104, only one user device 102 and two or more wireless access nodes 104, two or more user devices 102 and one or more wireless access nodes 104, or two or more wireless access nodes 104 without any user devices 102.

In general, a user device as described herein, such as the user devices 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100, such as a user device 102 and a wireless access node 104, two user devices 102 without a wireless access node 104, or two wireless access nodes 104 without a user device 102, may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in various embodiments, two or more of the communication nodes in the wireless system 100, may be configured to communicate according to vehicle networking standards and/or specifications. As used herein, vehicle networking refers to a large-scale system for wireless communication and information exchange involving a vehicle, pedestrians, roadside equipment and the Internet in accordance with any of various communication protocols and data exchange standards. Vehicle networking communications may enhance vehicle performance with respect to driving safety, traffic efficiency, usability or user convenience features, or entertainment. Additionally, in any of various embodiments, vehicle networking communication may be categorized into three types: communication between vehicles (also called vehicle-to-vehicle (V2V)); communication between a vehicle and roadside equipment/network infrastructure (called vehicle-to-infrastructure/vehicle-to-network (V2I/V2N)); and communication between vehicles and pedestrians (called vehicle-to-pedestrian (V2P)). These types of communications are collectively referred to as vehicle-to-everything (V2X) communication. Communication nodes participating in V2X communicates may communicate with each other according to any of various V2X standards or specifications.

In the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a sending node and a receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to another wireless access node 104. Also, for sidelink transmissions, a first/source user device 102 directly transmits a sidelink signal to a second/destination user device 102 without any forwarding of the sidelink signal to a wireless access node 104.

For at least some embodiments involving V2X communication, user devices 102 may perform sidelink transmissions. Such sidelink communications in V2X may be referred to as a PC5-based V2X communication or V2X communication. Additionally, for sidelink communications in V2X, user device 102 may communicate sidelink signals to each other using a PC5 interface, where PC5 refers to a reference point where a user device 102 communicates with another user device 102 over a direct channel.

As V2X technology advances, including in the automation industry, scenarios for V2X communications are being increasingly diversified and require higher performance. Examples of advanced V2X services include vehicle platooning, extended sensors, advanced driving (semi-automated driving and full-automated driving), and remote driving. Example performance requirements for these advanced V2X services may include: supporting data packets with a size of 50 to 12,000 bytes, a transmission rate of 2 to 50 messages per second, a maximum end-to-end delay of 3 to 500 milliseconds, a reliability of 90% to 99.999%, a date rate of 0.5 to 1,000 Megabytes per second (Mbps), or a transmission range of 50 to 1,000 meters, as non-limiting examples.

In addition, communication nodes using NR radio access operating with shared spectrum channel access may be configured to operate in different modes, where primary cells (PCells), primary secondary cells (PSCells) or secondary cells (SCells) can be in the shared spectrum, and an SCell may or may not be configured with uplink transmissions. Further, in both channel access modes, the wireless access node 104 and the user device 102 may be configured to apply or perform listen-before-talk (LBT) procedures before performing a transmission on a cell configured with shared spectrum channel access.

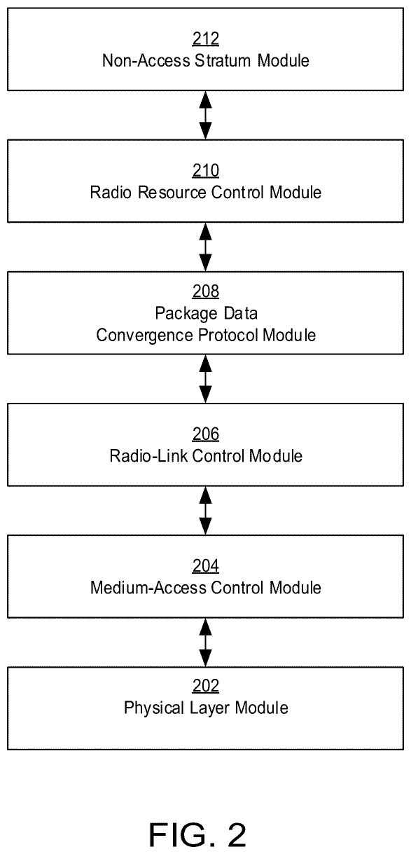

FIG. 2 shows a block diagram of a plurality of modules of a communication node (e.g., a user device 102 or a wireless access node 104), including a physical layer (PHY) entity or module (also called herein as just PHY layer, PHY module, or PHY entity) 202, a medium-access control (MAC) layer entity or module (also called herein as just MAC layer, MAC module, or MAC entity) 204, a radio-link control (RLC) layer entity or module (also called herein as just RLC layer, RLC entity, or RLC module) 206, a package data convergence protocol (PDCP) layer entity or module (also called herein as just PDCP layer, PDCP entity, or PDCP module) 208, a radio resource control (RRC) layer entity or module (also called herein as just RRC layer, RRC entity, or RRC module) 210, and a Non-Access Stratum (NAS) layer entity or module (also called herein as just NAS layer, NAS entity, or NAS module) 212.

In the present disclosure, as used herein unless expressed otherwise, the terms “layer”, “entity”, and “module”, used alone or in combination with each other, and as used for one or more components of a communication node, is an electronic device, such as electronic circuit, that includes hardware or a combination of hardware and software. In various embodiments, a module or an entity may be considered part of, or a component of, or implemented using one or more of the components of a communication node of FIG. 1, including a processor 110/120, a memory 112/122, a transceiver circuit 106/114, or the antenna 108/116. For example, the processor 110/120, such as when executing computer code stored in the memory 112/116, may perform the functions of a module or entity. Additionally, in various embodiments, the functions that a module or entity performs may be defined by one or more standards or protocols, such as 5G NR for example.

Additionally, the layer entities 202-212 in FIG. 2 may be higher and lower layers relative to each other, with the PHY layer entity 202 being the lowest layer among the layer entities 202-212; the MAC layer entity 204 being a higher layer than the PHY layer entity 202 and lower than the other layer entities 206-212; the RLC layer entity 206 being higher than the PHY and MAC layer entities 202, 204 and lower than the PDCP, RRC, and NAS layer entities 208-212; the PDCP layer entity 208 being higher than the PHY, MAC, and RRC layer entities 202-206 and lower than the RRC and NAS layer entities 210, 212; the RRC layer entity 210 being higher than the PHY, MAC, RRC, and PDCP layer entities 202-208 and lower than the NAS layer entity 212; and the NAS layer entity 212 being the highest layer entity among the layer entities 202-220 shown in FIG. 2. In various embodiments, a communication node of the system 100 may include modules and/or layer entities other than those shown in FIG. 2.

### CAPC Value:

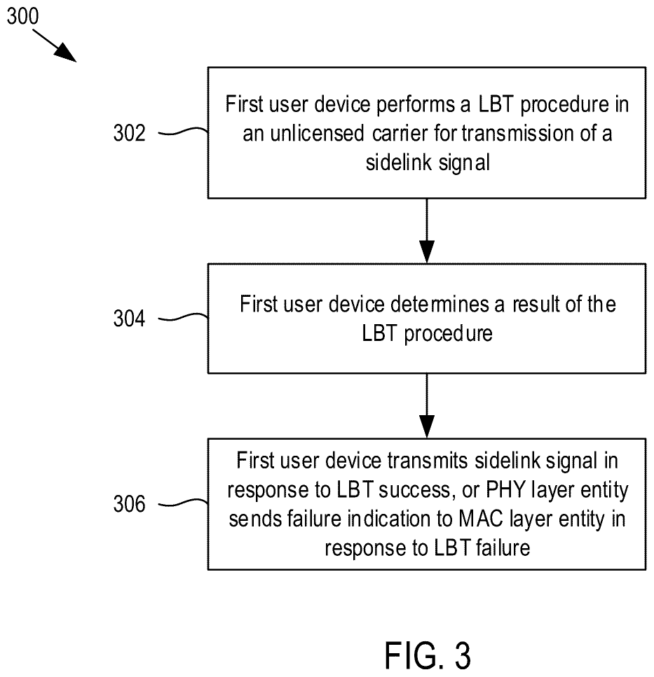

FIG. 3 shows a schematic diagram of a method 300 according to an embodiment of the present disclosure. The method 300 is for wireless communications that includes sidelink communications between the first user device 102(1) and the second user device 102(2) on an unlicensed carrier. The embodiments of the method 300 have the first user device 102(1) functioning as a source or transmitting user device that transmits a sidelink signal to the second user device 102(2), and the second user device 102(2) functioning as a destination or receiving user device that receives the sidelink signal from the first user device 102(1).

In the present disclosure, a licensed carrier is a carrier, frequency band or spectrum that is licensed by a government or other authoritative entity (e.g., the Federal Communications Commission (FCC) in the United States or the European Telecommunications Standards Institute (ETSI) in Europe) to a service provider for exclusive use. An unlicensed carrier, also called a shared spectrum, is a carrier, frequency band or spectrum that is not licensed by a government or other authoritative entity.

At block 302, the first user device 102(1) may perform a listen-before-talk (LBT) procedure in an unlicensed carrier for transmission of a sidelink signal. In general, when a user device 102 wants to transmit a signal (e.g., an uplink signal or a sidelink signal) on a channel in a particular carrier (unlicensed), the user device may perform an LBT procedure in the carrier before transmitting the signal. During an LBT procedure, the user device 102 may listen to or sense the channel to determine whether the channel is available (free) or busy. In response to, or as a result of, performing the LBT procedure, the user device 102 may determine whether the LBT procedure is a success or a failure. The success indicates that the channel is available, and in turn, the user device 102 can proceed to transmit the signal. The failure indicates that the channel is busy, and in turn, the user device 102 determines not to transmit the signal.

In various embodiments, at block 302, the first user device 102(1) may perform the LBT procedure according to a sidelink channel access priority. Specifically, during the LBT procedure, an amount of time that the first device 102 has to monitor the channel may depend on a value of the sidelink channel access priority. Also, in an event that the result of the LBT procedure is a success, an amount of time resources the channel occupies may depend on the value of the sidelink channel access priority.

In some of these embodiments, the sidelink channel access priority is a sidelink channel access priority of a sidelink logical channel. For example, the first user device 102(1) may be configured with a plurality of logical channels, and each logical channel may have or be mapped to an associated priority value for a sidelink channel access priority. The priority values may be the same as or different from each other for the different logical channels. Correspondingly, when the first user device 102(1) determines to transmit data (e.g., data of a MAC protocol data unit (PDU)) as part of the sidelink signal, the first user device 102(1) may determine a logical channel that corresponds to the data, and in turn, determine a priority value corresponding to the logical channel. The first user device 102(1) may then perform the LBT procedure according to the determined priority value.

In addition, for at least some embodiments, the data (e.g., of the MAC PDU) may correspond to multiple logical channels. Correspondingly, the first user device 102(1) may determine a plurality of priority values for the multiple logical channels, and then select a value corresponding to a highest priority value from among the plurality of priority values. In other embodiments, the first user device 102(1) may determine a plurality of priority values for the multiple logical channels, and then select a value corresponding to a lowest priority value among the plurality of priority values.

In some embodiments, the sidelink channel access priority is a sidelink channel access priority of a quality of service (QOS) profile. The QoS profile may identify a set of QoS parameters corresponding to data to be transmitted, such as a sidelink PC5 QoS Identifier (PQI), a sidelink guaranteed flow bit rate (GFBR), a sidelink maximum flow bit rate (MFBR), and/or a sidelink range. For such embodiments, the first user device 102(1) may identify a QoS profile corresponding to data to be transmitted in the sidelink transmission. In turn, the first user device 102(1) may identify a PQI or the best matched PQI corresponding to the QoS profile. In addition, for at least some embodiments, the data (e.g., of the MAC PDU) may correspond to multiple PC5 QoS profiles. Correspondingly, the first user device 102(1) may determine a plurality of PQI values for the multiple QoS profiles and select a value corresponding to the highest CAPC value among (the CAPC values corresponding to) the plurality of PQI values. In some embodiments, the first user device 102(1) may determine a plurality of PQI values for the multiple QoS profiles and select a value corresponding to the lowest or highest CAPC value among (the CAPC values corresponding to) the plurality of PQI values. In some embodiments, the first user device 102(1) may determine a plurality of PDB values for the multiple QoS profiles and select a value corresponding to the lowest or the highest CAPC value among (the CAPC values corresponding to) the plurality of PDB values. The first user device 102(1) may perform the LBT procedure according to the determined priority value.

In some embodiments, the first user device 102(1) may use a default CAPC value for a QoS flow corresponding to a non-standardized PQI in response to that there is no configured CAPC for this non-standardized PQI or this non-standardized PQI is mapped to a default DRB.

In an embodiment, the default CAPC value may be received from the network or be preconfigured in the UE.

### Resource Allocation

In some embodiment, for performing the sidelink communications, the UE may use mode 1 and/or mode 2 resource allocation mechanism to transmit sidelink data. For mode 2 resource allocation mechanism, the transmission resource is selected by the UE itself within a configured resource pool. For the mode 1 resource allocation mechanism, the transmission resource is scheduled by the network. When the mode 1 resource allocation mechanism is used, the network may schedule more than one transmission resource in DCI (downlink control information) via a PDCCH (physical downlink control channel). If the UE does not complete the transmission (e.g., does not receive HARQ ACK (hybrid automatic repeat request acknowledgement) information from a peer UE) or considers more re-transmissions are needed, the UE may send a HARQ NACK to the network for requesting more transmission resources.

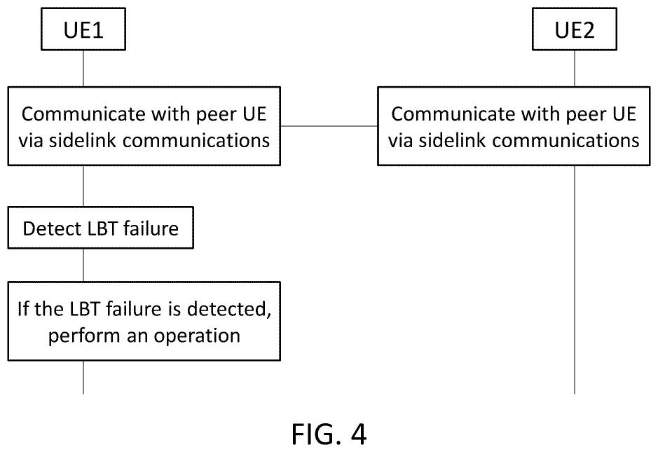

FIG. 4 shows a schematic diagram of a sidelink communication according to an embodiment of the present disclosure. In FIG. 4, the UE1 communication with peer UE (i.e., UE2) via sidelink communications (in an unlicensed spectrum). The UE1 performs a LBT procedure for the sidelink communication and detects whether there is a LBT failure or LCT success. If detecting the LBT failure, the UE1 performs an operation including at least one of:
triggering resource re-selection;
removing the LBT failure resource(s) from the selected sidelink resource;
dropping the LBT failure resource(s) from the selected sidelink resource; or
randomly selecting a resource from the resources indicated by the physical layer and replace the removed or dropped resource(s) by the selected resource(s).

In some embodiments, the network can dynamically allocate resources to the UE via the SL-RNTI (sidelink radio network temporally identifier) on PDCCH(s) (Physical Downlink Control Channel(s)) for NR sidelink communications.

In addition, the network may allocate sidelink resources to the UE by using two types of configured sidelink grants:
Type 1 configured sidelink grant: The RRC layer directly provides the configured sidelink grant only for the NR sidelink communications; and
Type 2 configured sidelink grant: The RRC layer defines the periodicity of the configured sidelink grant while the PDCCH can be used to either signal and activate the configured sidelink grant or deactivate the configured sidelink grant. The PDCCH is addressed to SL-CS-RNTI (sidelink configured scheduling RNTI) for the NR sidelink communications.

In addition, the network may also semi-persistently allocate sidelink resources to the UE via the SL Semi-Persistent Scheduling V-RNTI on PDCCH(s) for the V2X sidelink communications.

For the UE performing the NR sidelink communications, there can be more than one configured sidelink grant activated at a time on the carrier configured for the sidelink transmissions.

In addition, with the configured sidelink grants, the network can allocate sidelink resources for initial HARQ transmissions and HARQ retransmissions to UEs.

### CG for Retransmission:

In some embodiments, the network may allocate sidelink resources to the UE when the UE is in an RRC connected state. In these embodiments, the network may configure sl-PUCCH-Config to the UE via RRC message(s), to provide PUCCH resources. The UE can signal a HARQ feedback on the PUCCH. If the UE signals a negative acknowledgement (NACK) on the PUCCH, the network may allocate sidelink resources for an autonomous retransmission.

In the present disclosure, the autonomous retransmission may be equal to retransmission.

In an embodiment, if the network does not configure the sl-PUCCH-Config to provide PUCCH resource via the RRC message(s), the UE is allowed to perform the retransmission on configured sidelink grants.

In an embodiment, the network may indicate the UE whether the configured sidelink grants can be used to perform the autonomous retransmission or not.

For example, if the UE receives, from the network, configuration information indicating that the configured sidelink grants can be used to perform the autonomous retransmission, the UE can use the configured sidelink grants to perform the autonomous retransmission for this TB.

In an embodiment, for a HARQ process, when the UE does not perform a sidelink transmission on a previous dynamic grant and/or previous configured grant for a TB because an LBT failure is detected, the UE can use configured sidelink grants to perform autonomous retransmission for this TB.

In an embodiment, when the UE does not perform a sidelink transmission on a previous configured grant for transmitting a TB because an LBT failure is detected, the UE can use the configured sidelink grants to perform the autonomous retransmission for this TB.

Note that the previous dynamic grant and/or previous configured grant represents the dynamic grant and/or configured grant which is (configured) before the configured sidelink grants in time domain.

In an embodiment, the UE can use the configured sidelink grants to perform the autonomous retransmission for this TB if the associated HARQ process is pending.

In an embodiment, for the configured sidelink grants, a HARQ Process ID associated with the first slot of an SL transmission is derived from the following equation:

HARQ Process ID=[floor(CURRENT_slot/PeriodicitySL)] modulo sl-NrOfHARQ-Processes+sl-HARQ-ProcID-offset,
where CURRENT_slot refers to current logical slot in the associated resource pool.

In an embodiment, if the UE use different configured sidelink grants corresponding to different HARQ Process IDs to transmit the same TB, the UE may map these different HARQ Process IDs to one Sidelink process ID in the MAC entity.

In an embodiment, to handle potential LBT failures on the configured grants (CGs), the UE may be allowed to use the configured sidelink grant(s) within other CG period to transmit the same TB.

In an embodiment, the MAC entity (of the UE) includes at most one Sidelink HARQ entity for transmissions on the SL-SCH (sidelink shared channel), which maintains a number of parallel Sidelink processes. One sidelink process may be configured for transmissions of multiple MAC PDUs. In addition, one delivered sidelink grant and its associated Sidelink transmission information are associated with a Sidelink process. Each Sidelink process supports one TB.

For each sidelink grant, the HARQ entity identifies the HARQ process associated with this grant and for each identified HARQ process:
if the sidelink transmission is performed and an LBT failure indication is received from lower layers, the UE considers/determines/sets (a HARQ process status of) the identified HARQ process as pending.

In an embodiment, (the HARQ process status of) each associated HARQ process is considered as not pending when:
a transmission is performed on that HARQ process and an LBT failure indication is not received from lower layers; and/or
the HARQ buffer for this HARQ process is flushed.

In the present disclosure, the lower layer may be a layer lower than the MAC layer.

In an embodiment, for each sidelink grant, the HARQ entity may identify the HARQ process associated with this grant. For each identified HARQ process:
if the sidelink transmission is performed, the UE increments a first number of transmissions of the MAC PDU by 1, and/or
if the sidelink transmission is performed and an LBT failure indication is not received or received from the lower layers, the UE increments the first number of transmissions of the MAC PDU by 1.

In an embodiment, for each sidelink grant, the HARQ entity shall identify the HARQ process associated with this grant. For each identified HARQ process:

if the sidelink transmission is performed and an LBT failure indication is not received from lower layers, the UE increments a second number of transmissions of the MAC PDU by 1.

In an embodiment, if the first number of transmissions of the MAC PDU reaches to a first Max TransNum (maximum transmission number) and/or if the second number of transmissions of the MAC PDU reaches to a second MaxTransNum, the UE flushes the HARQ buffer of Sidelink process associated with the HARQ Process ID.

PSSCH (Physical Sidelink Shared Channel) TRANSMISSION OPPORTUNITY

In some embodiments, if the configured sidelink grant has been activated and a PSSCH duration corresponds to the first (1st) PSSCH transmission opportunity or any PSSCH transmission opportunity within a sl-PeriodCG (i.e., period) of the configured sidelink grant, and
if the corresponding sidelink HARQ process is not pending, or
if the corresponding sidelink HARQ process is pending and the configured sidelink grant cannot fulfil the remaining PDB of the data in a logical channel, or
if the corresponding sidelink HARQ process is pending and the configured sidelink grant cannot fulfil the latency requirement of the MAC CE if included,
the UE can perform at least one of:
   considering/determining that an NDI (new data indicator) bit for the corresponding sidelink HARQ process have been toggled,
   determining that this PSSCH duration is used for an initial transmission,
   flushing the HARQ buffer of the Sidelink process associated with the HARQ Process ID.

In an embodiment, the UE then delivers the configured sidelink grant and the associated HARQ information to the HARQ entity.

In some embodiments, if the configured sidelink grant has been activated and a PSSCH duration corresponds to the first (1st) PSSCH transmission opportunity or any PSSCH transmission opportunity within this sl-PeriodCG (i.e., period) of the configured sidelink grant, and
if the corresponding sidelink HARQ process is pending, or
if the corresponding sidelink HARQ process is pending and the configured sidelink grant can fulfil the remaining PDB of the data in a logical channel, or
if the corresponding sidelink HARQ process is pending and the configured sidelink grant can fulfil the latency requirement of the MAC CE if included,
the UE delivers the configured sidelink grant and the associated HARQ information to the HARQ entity. The HARQ entity may further instruct the associated Sidelink process to trigger a retransmission.

In some embodiments, the UE may perform the following steps:

Step 1: Receive configuration information for configured sidelink grant from the network or from a peer UE.

In an embodiment, the configuration information includes at least one of:
a first timer value; or
a first MaxTransNum or a first MaxTransNum list, which indicates the maximum number of times that a TB can be transmitted by using the configured sidelink grant.

In an embodiment, the first MaxTransNum is corresponding to a CAPC value in the MAC PDU.

In an embodiment, the first MaxTransNum is corresponding to each configured sidelink grant.

Step 2: Perform a sidelink communication/transmission according to the configuration information.

In an embodiment:
if the configured sidelink grant has been activated and a PSSCH duration corresponds to the first (1st) PSSCH transmission opportunity or any PSSCH transmission opportunity within this sl-PeriodCG (i.e., period) of the configured sidelink grant, and:
   if the corresponding sidelink HARQ process is pending and the first timer is not running, or
   if the corresponding sidelink HARQ process is pending and the first number of transmissions of the MAC PDU reaches the first Max TransNum, or
   if the corresponding sidelink HARQ process is pending and the configured sidelink grant cannot fulfil the remaining PDB of the data in a logical channel, or
   if the corresponding sidelink HARQ process is pending and the configured sidelink grant cannot fulfil the latency requirement of the MAC CE if included,
the UE may perform at least one of:
   considering/determining the NDI bit for the corresponding sidelink HARQ process to have been toggled;
   determining that this PSSCH duration is used for initial transmission; or
   flushing the HARQ buffer of Sidelink process associated with the HARQ Process ID.

The UE may further deliver the configured sidelink grant and the associated HARQ information to the HARQ entity.

In an embodiment:
if the configured sidelink grant has been activated and a PSSCH duration corresponds to the first (1st) PSSCH transmission opportunity or any PSSCH transmission opportunity within this sl-PeriodCG of the configured sidelink grant, and
   if the corresponding sidelink HARQ process is pending and the first number of transmissions of the MAC PDU is less than the first MaxTransNum, or
   if the corresponding sidelink HARQ process is pending and the first timer is running, or
   if the corresponding sidelink HARQ process is pending and the configured sidelink grant can fulfil the remaining PDB of the data in a logical channel, or
   if the corresponding sidelink HARQ process is pending and the configured sidelink grant can fulfil the latency requirement of the MAC CE if included,
the UE delivers the configured sidelink grant and the associated HARQ information to the HARQ entity.

In an embodiment, the UE starts or restarts the first timer, if configured, for a HARQ process when the corresponding (sidelink) transmission is performed if an LBT failure indication is not received from the lower layer. As an alternative or in addition, the UE starts or restarts the first timer, if configured, for a HARQ process when the corresponding (sidelink) transmission is performed if an LBT failure indication is received from the lower layers.

In an embodiment:
if the configured sidelink grant has been activated and a PSSCH duration corresponds to any PSSCH transmission opportunity other than the first (1st) PSSCH transmission opportunity within this sl-PeriodCG (i.e., period) of the configured sidelink grant, and
   if the corresponding sidelink HARQ process is not pending, or
   if the corresponding sidelink HARQ process is pending and the configured sidelink grant cannot fulfil the remaining PDB of the data in a logical channel, or
   if the corresponding sidelink HARQ process is pending and the configured sidelink grant cannot fulfil the latency requirement of the MAC CE if included,
the UE ignores the sidelink grant.

Optionally, the UE may further flush the HARQ buffer of the Sidelink process associated with the HARQ Process ID.

In an embodiment:
if the configured sidelink grant has been activated and a PSSCH duration corresponds to any PSSCH transmission opportunity other than the first (1st) PSSCH transmission opportunity within this sl-PeriodCG (i.e., period) of the configured sidelink grant, and
   if the corresponding sidelink HARQ process is pending, or
   if the corresponding sidelink HARQ process is pending and the configured sidelink grant can fulfil the remaining PDB of the data in a logical channel, or
   if the corresponding sidelink HARQ process is pending and the configured sidelink grant can fulfil the latency requirement of the MAC CE if included,
the UE delivers the configured sidelink grant and the associated HARQ information to the HARQ entity.

In an embodiment, the UE may perform the following steps:

Step 1: Receive, from the network or from a peer UE, configuration information for a configured sidelink grant.

In an embodiment, the configuration information include at least one of:
a first timer value; or
a first MaxTransNum or a first MaxTransNum list, which indicate the maximum number of times that a TB can be transmitted by using the configured sidelink grant.

In an embodiment, the first MaxTransNum is corresponding to a CAPC value in the MAC PDU.

In an embodiment, the MaxTransNum is corresponding to each configured sidelink grant.

Step 2: Perform a sidelink communication/transmission according to the configuration information.

In an embodiment:
if the configured sidelink grant has been activated and this PSSCH duration corresponds to any PSSCH transmission opportunity other than the first (1st) PSSCH transmission opportunity within this sl-PeriodCG of the configured sidelink grant, and
   if the corresponding sidelink HARQ process is pending and the first timer is not running, or
   if the corresponding sidelink HARQ process is pending and the first number of transmissions of the MAC PDU has been reached to the first Max TransNum, or
   if the corresponding sidelink HARQ process is pending and the configured sidelink grant cannot fulfil the remaining PDB of the data in a logical channel, or
   if the corresponding sidelink HARQ process is pending and the configured sidelink grant cannot fulfil the latency requirement of the MAC CE if included,
the UE ignores the configured sidelink grant.

Optionally, the UE may flush the HARQ buffer of the Sidelink process associated with the HARQ Process ID.

In an embodiment:
if the configured sidelink grant has been activated and a PSSCH duration corresponds to any PSSCH transmission opportunity except the first (1st) PSSCH transmission opportunity within this sl-PeriodCG of the configured sidelink grant, and
   if the corresponding sidelink HARQ process is pending and the first number of transmissions of the MAC PDU is less than the first Max TransNum, or
   if the corresponding sidelink HARQ process is pending and the first timer is running, or
   If the corresponding sidelink HARQ process is pending and the configured sidelink grant can fulfil the remaining PDB of the data in a logical channel, or
   if the corresponding sidelink HARQ process is pending and the configured sidelink grant can fulfil the latency requirement of the MAC CE if included,
the UE delivers the configured sidelink grant and the associated HARQ information to the HARQ entity.

In an embodiment, the UE perform the following steps:

Step 1: Receive, from the network or the peer UE, configuration information for a configured sidelink grant

In this embodiment, the configuration information include at least one of:
a first timer value,
a second timer value, or
a second MaxTransNum, which indicates the maximum number of times that a TB can be transmitted using the configured sidelink grant due to the LBT failure.

In an embodiment, the second MaxTransNum is corresponding to the CAPC value in the MAC PDU.

In an embodiment, the second MaxTransNum is corresponding to each configured sidelink grant.

Step 2: Perform sidelink communication/transmission according to the configuration information.

In an embodiment:
if the configured sidelink grant has been activated and a PSSCH duration corresponds to the first (1st) PSSCH transmission opportunity or any PSSCH transmission opportunity within this sl-PeriodCG of the configured sidelink grant, and
   if the first timer is not running for the corresponding sidelink HARQ process, or
   if the first timer is running and the second timer is not running for the corresponding sidelink HARQ process, or
   if the configured sidelink grant cannot fulfil the remaining PDB of the data in a logical channel, or
   if the configured sidelink grant cannot fulfil the latency requirement of the MAC CE if included, or
   if the second number of transmissions of the MAC PDU reaches the second Max TransNum,
the UE may perform at least one of:
   considering/determining that the NDI bit for the corresponding sidelink HARQ process has been or is toggled,
   determining that this PSSCH duration is used for an initial transmission; or
   flushing the HARQ buffer of Sidelink process associated with the HARQ Process ID.

The UE may further deliver the configured sidelink grant and the associated HARQ information to the HARQ entity.

In an embodiment:
if the configured sidelink grant has been activated and a PSSCH duration corresponds to any PSSCH transmission opportunity but not the first (1st) PSSCH transmission opportunity within this sl-PeriodCG of the configured sidelink grant, and
   if the first timer is not running for the corresponding sidelink HARQ process, or
   if the first timer is running and the second timer is not running for the corresponding sidelink HARQ process, or
   if the configured sidelink grant cannot fulfil the remaining PDB of the data in a logical channel, or
   if the configured sidelink grant cannot fulfil the latency requirement of the MAC CE if included, or
   if the second number of transmissions of the MAC PDU has been reached to the second Max TransNum,
the UE ignores the configured sidelink grant.

Optionally, the UE may further flush the HARQ buffer of Sidelink process associated with the HARQ Process ID.

### Mode 2 Resource Allocation

In an embodiment, the first UE may perform an LBT procedure in an unlicensed carrier for transmitting a sidelink signal. For example, when the UE wants to transmit data on a channel in a particular carrier (e.g., unlicensed carrier), the UE may perform the LBT procedure in the carrier before transmitting the sidelink signal. If the LBT detection fails (i.e., the unlicensed carrier is busy or there is signal transmitted on the unlicensed carrier), the UE cannot transmit the data on the unlicensed carrier.

In an embodiment of the UE being configured with the mode 2 resource allocation, the transmission resource is selected by the UE itself within a configured resource pool. Considering that the LBT process on the selected sidelink resource may fail, the UE may select more than one sidelink resource. In order to avoid wasting the sidelink resources, the UE may receive the configuration information from the network or preconfigured with the configuration information in an embodiment, The configuration information includes a third sidelink Max TransNum which indicates the max number of transmissions of the sidelink MAC PDU. The third sidelink Max TransNum may be corresponding to the CAPC value of the MAC PDU.

In an embodiment, if the UE is configured with the mode 2 resource allocation, the UE selects the number of HARQ retransmissions from the allowed numbers, which is less than the third sidelink Max TransNum.

### UL/SL Prioritizing

In various embodiments, the first user device 102(1) may prioritize some transmissions over other transmissions.

In some situations, if the first user device 102(1) prioritizes a first transmission over a second transmission, the first user device 102(1) may drop the second transmission.

In the case that the second transmission is a sidelink transmission on the unlicensed carrier, not performing the sidelink transmission on the sidelink grant in the resource set indicated by a COT (Channel Occupancy Time) may cause the first user device 102(1) or other user device to lose the resources acquired for the sidelink transmission. Consequently, the first user device 102(1) may need to acquire additional resources for the sidelink transmission. As a result, a package delay budget (PDB) of the data for the sidelink transmission may expire, which may lead to a failure of the sidelink data transmission/reception.

To minimize such failures, in various embodiments, the first user device 102(1) may determine whether to prioritize the transmissions on the unlicensed carriers over the transmissions on the licensed carriers and/or whether to prioritize the sidelink transmissions over the uplink transmissions.

In some embodiments, the first user device 102(1) may determine to prioritize one of the first and second transmissions if it is unable to simultaneously perform the first transmission (e.g., sidelink transmission) and the second transmissions.

In an embodiment, the first user device 102(1) may prioritize the sidelink transmission over the second transmission when/if the sidelink transmission is performed on the unlicensed carrier and/or the sidelink grant of the sidelink transmission is in the resource set indicated by the COT. Note that, the second transmission may be another sidelink transmission or an uplink transmission.

In an embodiment, the first UE prioritizes the sidelink transmission over a second transmission in response to:
the sidelink transmission being on the unlicensed carrier and the second transmission being on a licensed carrier, and/or
in response to a sidelink grant of the sidelink transmission is in the resource set indicated by the COT.

In an embodiment, the COT is received from a second UE (e.g., peer UE) or the COT is generated by the first UE.

In an embodiment the second transmission comprises an uplink transmission.

In an embodiment, prioritizing the sidelink transmission on the unlicensed carrier over the uplink transmission on the licensed carrier is in response to the uplink transmission not being prioritized by a Non-Access-Stratum (NAS) layer entity of the first UE or a layer entity higher than the PHY layer entity of the first UE.

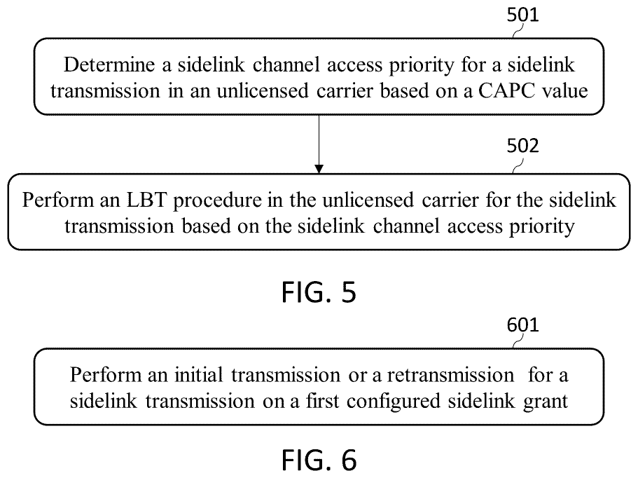

FIG. 5 shows a flowchart of a method according to an embodiment of the present disclosure. The method shown in FIG. 5 may be used in a wireless terminal (e.g. UE) and comprises the following steps:

Step 501: Determine a sidelink channel access priority for a sidelink transmission in an unlicensed carrier based on a CAPC value.

Step 502: Perform an LBT procedure in the unlicensed carrier for the sidelink transmission based on the sidelink channel access priority.

In this embodiment, the wireless terminal determines a sidelink channel access priority for a sidelink transmission in an unlicensed carrier based on a CAPC value and performs an LBT procedure in the unlicensed carrier for the sidelink transmission based on the determined sidelink channel access priority. Note that the CAPC value used for determining the sidelink channel access priority is selected from a plurality of CAPC values associated with a plurality of QoS files of the sidelink transmission.

In an embodiment, the plurality of CAPC values is corresponding to a plurality of PQI values (determined) for the plurality of QoS files.

In an embodiment, the plurality of CAPC values is corresponding to a plurality of PDB values (determined) for the plurality of QoS files.

In an embodiment, the selected CAPC value is the lowest or the highest CAPC value in the plurality of CAPC values.

In an embodiment, the selected CAPC value is a default CAPC value for a QoS flow corresponding to a non-standardized PQI.

In an embodiment, the non-standardized PQI has no corresponding CAPC value or is mapped to a default DRB.

FIG. 6 shows a flowchart of a method according to an embodiment of the present disclosure. The method shown in FIG. 6 may be used in a wireless terminal (e.g., UE) and comprises the following step:

Step 601: Perform an initial transmission or a retransmission for a sidelink transmission on a first configured sidelink grant.

In FIG. 6, the wireless terminal performs an initial/new transmission or a (n) (autonomous) retransmission (e.g., HARQ retransmission) on a first configured sidelink grant.

In the present disclosure, the transmission/retransmission on a configured sidelink grant may refer to the transmission/retransmission on resources configured by/associated with the configured sidelink grant.

In an embodiment, performing the initial/new transmission refers to initiating a transmission.

In an embodiment, the wireless terminal performs the retransmission in response to that the wireless terminal does not receive, from a wireless network node, a sidelink configuration for at least one PUCCH resource (e.g., sl-PUCCH-Config) or in response to that the wireless terminal receives, from a wireless network node, configuration information indicating that (at least one resource associated with) the first configured sidelink grant can be used for the retransmission for the sidelink transmission. In this embodiment, (the resource of) the first configured sidelink grant is not a 1st sidelink data transmission resource configured by the configured sidelink grant in a period.

In an embodiment, the wireless performs the initial/new transmission for the sidelink transmission on the first configured sidelink grant in response to at least one of:
the wireless terminal receives, from a wireless network node, a sidelink configuration for at least one physical uplink control channel resource; or
the wireless terminal does not receive, from a wireless network node, configuration information indicating that at least one resource associated with the first configured sidelink grant can be used for the retransmission for the sidelink transmission, or
the wireless terminal receives, from a wireless network node, configuration information indicating that at least one resource associated with the first configured sidelink grant cannot be used for the retransmission for the sidelink transmission.

In an embodiment, the first configured sidelink grant (for performing the initial/new transmission) is the 1^{st} sidelink data transmission resource configured by the configured sidelink grant in a period.

In an embodiment, the wireless terminal performs the retransmission for the sidelink transmission on the first configured sidelink grant in response to at least one of:
the sidelink transmission is not performed on a previous dynamic sidelink grant because an LBT failure is detected,
the sidelink transmission is not performed on a previous configured sidelink grant because an LBT failure is detected,
the sidelink transmission is performed on a previous configured sidelink grant for the associated HARQ process and that a MAC entity does not receive, from a layer entity lower than the MAC entity, an indication of an LBT failure,
the associated HARQ process is pending,
the configured sidelink grant capable of fulfilling a remaining PDB of retransmission data associated with the sidelink HARQ process, or
the configured sidelink grant can fulfils a latency requirement of a MAC CE if included (e.g., in the sidelink transmission).

In an embodiment, the wireless terminal performs the sidelink transmission on a resource associated with a second configured sidelink grant. In this embodiment, the wireless terminal may map a first HARQ process identifier associated with the first configured sidelink grant and a second HARQ process identifier associated with the second configured sidelink grant to a one sidelink process identifier of the sidelink transmission in a MAC entity.

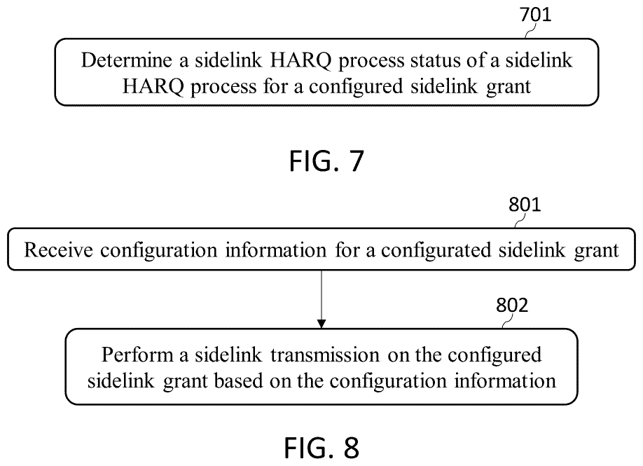

FIG. 7 shows a flowchart of a method according to an embodiment of the present disclosure. The method shown in FIG. 7 may be used in a wireless terminal (e.g. UE or MAC entity) and comprises the following step:

Step 701: Determine a sidelink HARQ process status of a sidelink HARQ process for a configured sidelink grant.

In FIG. 7, the wireless terminal determines sidelink HARQ process status of a sidelink HARQ process for a configured sidelink grant. Based on the determined sidelink HARQ process status, the wireless terminal is able to determine whether a transmission on the configured sidelink grant is a new/initial transmission or a retransmission.

In an embodiment, the wireless terminal may perform at least one of: determining that a new data indicator for the corresponding sidelink HARQ process is toggled, determining that a sidelink data transmission duration associated with the configured sidelink grant is used for initial transmission, or flushing a HARQ buffer of the sidelink HARQ process. For example, wireless terminal may determine that the transmission on the configured sidelink grant is a new/initial transmission. In this embodiment, the wireless terminal performs the operation in response to at least one of:
the sidelink HARQ process status being set as non-pending,
the sidelink HARQ process status being set as pending and the configured sidelink grant capable of fulfilling a remaining PDB of retransmission data associated with the sidelink HARQ process, or
the sidelink HARQ process status being set as pending and the configured sidelink grant capable of fulfilling a latency requirement of a MAC CE if included.

Furthermore, the wireless terminal performs the operation(s) in response to a first timer is not running. That is the status of the first timer may also be a condition for determining whether the transmission on the configured sidelink grant is a new/initial transmission. In an embodiment, the first timer is for the sidelink HARQ process. For example, the first timer is configured to start or restart when a sidelink data transmission associated with the sidelink HARQ process is performed and is configured to stop in response to a reception of an ACK message for the sidelink data transmission.

Moreover, the wireless terminal performs the operation(s) in response to a first number of transmission times of a MAC PDU transmitted in a sidelink data transmission associated with the sidelink HARQ process is greater than or equal to (e.g., reaches) a first maximum transmission number. That is the number of transmission times of a MAC PDU transmitted in the sidelink data transmission associated with the sidelink HARQ process may also be a condition of determining whether the transmission on the configured sidelink grant is a new/initial transmission.

In an embodiment, the wireless terminal delivers, to a HARQ entity, the configured sidelink grant and HARQ information of the sidelink HARQ process (e.g., determines that the sidelink transmission on the configured sidelink grant is a retransmission). In this embodiment, the wireless terminal performs the deliver/transmission of the configured sidelink grant and HARQ information of the sidelink HARQ process in response to at least one of:
the sidelink HARQ process is pending,
the sidelink HARQ process is pending and the configured sidelink grant capable of fulfilling a remaining PDB of retransmission data associated with the sidelink HARQ process, or
the sidelink HARQ process is pending and that the configured sidelink grant can fulfils a latency requirement of a MAC CE if included.

In addition, the wireless terminal may receive, from the HARQ entity, an instruction of triggering a retransmission of a Sidelink transmission associated with the sidelink HARQ process.

In an embodiment, the wireless terminal performs the deliver/transmission of the configured sidelink grant and HARQ information of the sidelink HARQ process in response to a first number of transmission times of a MAC PDU transmitted in a sidelink data transmission associated with the sidelink HARQ process is less than a first maximum transmission number.

In an embodiment, the wireless terminal increments the first number of transmission times by 1 if the sidelink transmission is performed.

In an embodiment, the wireless terminal increments the first number of transmission times by 1 if the sidelink transmission is performed and a listen-before-talk failure is not received or received from a layer entity lower than the MAC entity.

In an embodiment, the wireless terminal receives, from a wireless network node or a peer wireless terminal of the sidelink data transmission, configuration information comprising at least one of a value of the first timer or the first maximum transmission number.

In an embodiment, the received first maximum transmission number is associated to a CAPC value.

In an embodiment, for each sidelink HARQ process, after MAC HAQR entity decides the MAC PDU and the related resource grant, the MAC entity pass the MAC PDU and the related resource grant to the PHY entity. That is a transmission is performed on the sidelink HARQ process. Next, the PHY entity performs the LBT procedure for this transmission. If the LBT procedure successes, no failure indication is sent to the MAC entity and the UE can performs PHY transmission. If the LBT procedure fails, the PHY entity sends the LBT failure indication to the MAC entity. The UE cannot perform real PHY transmission. In this case, from the viewpoint of MAC entity, the transmission is also performed on the sidelink HARQ process and the LBT failure is received from that PHY entity.

In an embodiment, the sidelink HARQ process status is determined as non-pending in response to at least one of:
a transmission is performed on the sidelink HARQ process and that the media access control entity does not receive, from a layer entity lower than the MAC entity, an indication of an LBT failure; or
the HARQ buffer for this HARQ process is flushed.

In an embodiment, the sidelink HARQ process status is determined as pending in response to that a transmission is performed on the sidelink HARQ process and that the MAC receives, from a layer entity lower than the MAC entity, an indication of an LBT failure.

In an embodiment, a sidelink data transmission resource is not a 1^{st} sidelink data transmission resource configured by the configured sidelink grant in a period. In this embodiment, the wireless terminal ignores the configured sidelink grant in response to at least one of:
the sidelink HARQ process status is set as non-pending,
the sidelink HARQ process status is set as pending and that the configured sidelink grant fulfils a remaining PDB of retransmission data associated with the sidelink HARQ process,
the sidelink HARQ process status is set as pending and that the configured sidelink grant fulfils a latency requirement of a MAC CE if included,
the sidelink HARQ process status is set as pending and that a first timer is not running, or
the sidelink HARQ process status is set as pending and that a first number of transmissions of the MAC PDU reaches a first maximum transmission number.

Optionally, the wireless terminal may further flush a HARQ buffer of an associated sidelink HARQ process for the sidelink transmission.

In an embodiment, after the wireless terminal determines the sidelink HARQ status, the wireless terminal may determines whether to perform an initial transmission or a retransmission for the sidelink transmission on the configured sidelink grant as recited in embodiments of the method shown in FIG. 6. That is the embodiments of the method shown in FIG. 7 may be combined with those of the method shown in FIG. 6.

FIG. 8 shows a flowchart of a method according to an embodiment of the present disclosure. The method shown in FIG. 8 may be used in a wireless terminal and comprises the following steps:

Step 801: Receive configuration information for a configurated sidelink grant.

Step 802: Perform a sidelink transmission on the configured sidelink grant based on the configuration information.

In this embodiment, the wireless terminal receives configuration information for a configurated sidelink grant and performs a sidelink transmission on the configured sidelink grant based on the configuration information.

In an embodiment, the configuration information comprises at least one of a value for a first timer, a value for a second timer or a second maximum transmission number.

In an embodiment, the configuration information is received from a wireless network node or a peer wireless terminal of the sidelink data transmission.

The network may or may not provide a dynamic sidelink grant for the sidelink retransmission. Under such a condition, the wireless terminal can be configured with a second timer, which is configured to start or restart after the sidelink data transmission is performed or after the corresponding PUCCH transmission carrying an SL (sidelink) HARQ feedback. When the second timer is running, the wireless terminal is not allowed to perform a retransmission on some of the resources associated with the configured sidelink grant.

In an embodiment, the second maximum transmission number is associated with a CAPC value.

In an embodiment, the wireless terminal may perform at least one of: determining that a new data indicator for the corresponding sidelink HARQ process is toggled, determining that a sidelink data transmission duration associated with the configured sidelink grant is used for initial transmission, or flushing a HARQ buffer of the sidelink HARQ process. The wireless terminal performs the operation(s) in response to:
a first timer is not running, wherein the first timer is configured to start or restart when the sidelink communication is performed for a sidelink HARQ process corresponding to the sidelink communication and is configured to stop in response to a reception of an acknowledgement message for the sidelink data transmission,
the first timer is running and a second timer is not running, wherein the second timer is configured to start or restart after the sidelink data transmission is performed or after the corresponding PUCCH transmission carrying an SL (sidelink) HARQ feedback,
the configured sidelink grant cannot fulfil a remaining PDB of data of the sidelink transmission,
the configured sidelink grant cannot fulfil a latency requirement of a MAC CE if included, or
a second number of transmission times of a MAC PDU in the sidelink transmission reaches a second maximum transmission number.

In an embodiment, the wireless terminal may further deliver, to a HARQ entity, the configured sidelink grant and HARQ information of the sidelink HARQ process.

In an embodiment, a sidelink data transmission resource for the sidelink transmission is a 1^{st} sidelink data transmission resource or any sidelink data transmission resource configured by the configured sidelink grant in a period.

In an embodiment, the wireless terminal may ignore the configured sidelink grant and/or flush an a HARQ buffer of the corresponding sidelink HARQ process in response to:
a first timer is not running, wherein the first timer is configured to start or restart when the sidelink communication is performed for a sidelink HARQ process corresponding to the sidelink communication and is configured to stop in response to a reception of an acknowledgement message for the sidelink data transmission, or
the first timer is running and a second timer is not running, wherein the second timer is configured to start or restart after the sidelink data transmission is performed for the sidelink HARQ process after the corresponding PUCCH transmission carrying the SL HARQ feedback, or
the configured sidelink grant cannot fulfil a remaining PDB of data of the sidelink transmission, or
the configured sidelink grant cannot fulfil a latency requirement of a MAC CE if included, or
a second number of transmission times of a MAC PDU in the sidelink transmission reaches a second maximum transmission number.

In an embodiment, a sidelink data transmission resource for the sidelink transmission is any sidelink data transmission resource configured by the configured sidelink grant in a period other than a 1^{st} sidelink data transmission resource configured by the configured sidelink grant in the period.

In an embodiment, the wireless terminal increments the second number of transmission times by 1 if the sidelink transmission is performed and an LBT is not received from a layer entity lower than the MAC entity.

In an embodiment, the wireless terminal increments the second number of transmission times by 1 if the sidelink transmission is performed (e.g., in view of MAC entity).

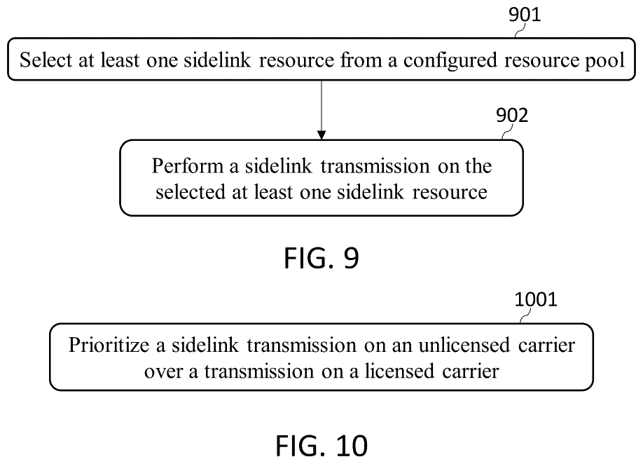

FIG. 9 shows a flowchart of a method according to an embodiment of the present disclosure. The method shown in FIG. 9 may be used in a wireless terminal and comprises the following steps:

Step 901: Select at least one sidelink resource from a configured resource pool.

Step 902: Perform a sidelink transmission on the selected at least one sidelink resource.

In FIG. 9, the wireless terminal selects at least one sidelink resource from a configured resource pool (i.e., mode 2 resource allocation) and performs a sidelink transmission on the selected at least one sidelink resource. In this embodiment, a number of retransmissions for a MAC PDU in the sidelink transmission is less than a third sidelink maximum transmission number.

In an embodiment, the wireless terminal receives, from a wireless network node, configuration information indicating the third sidelink maximum transmission number.

In an embodiment, the third sidelink maximum transmission number is preconfigured.

In an embodiment, the third sidelink maximum transmission number is associated with a CAPC value of the MAC PDU.

FIG. 10 shows a flowchart of a method according to an embodiment of the present disclosure. The method shown in FIG. 10 may be used in a wireless terminal and comprises the following step:

Step 1001: Prioritize a sidelink transmission on an unlicensed carrier over a transmission on a licensed carrier.

In FIG. 10, the wireless terminal may prioritize a sidelink transmission on an unlicensed carrier over a transmission on a licensed carrier. For example, the prioritization may be in response to that a resource on which the sidelink transmission is transmitted is associated with a resource set indicated by a COT. In this embodiment, if the wireless terminal cannot perform the sidelink transmission and the transmission simultaneously (e.g., when the sidelink transmission collides the transmission), the wireless terminal performs the sidelink transmission.

In an embodiment, the wireless terminal receives, from a second wireless terminal, information of the COT.

In an embodiment, the wireless terminal generates the COT.

In an embodiment, the transmission on the licensed carrier is an uplink transmission.

In an embodiment, the transmission on the licensed carrier is not prioritized by a layer entity higher than a PHY layer entity in the first wireless terminal.

In an embodiment, the layer entity higher than the PHY layer entity comprises a NAS layer entity.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the wireless communication method comprising:
determining a sidelink channel access priority for a sidelink transmission in an unlicensed carrier based on a channel access priority class value, and
performing a listen-before-talk (LBT) procedure in the unlicensed carrier for the sidelink transmission based on the sidelink channel access priority,
wherein the channel access priority class value is selected from a plurality of channel access priority class values associated with a plurality of quality of service (QOS) files of the sidelink transmission.

2. The wireless communication method of claim 1, wherein the plurality of channel access priority class values is corresponding to a plurality of PC5 QOS identifier (PQI) values or a plurality of packet delay budget values determined for the plurality of QoS files.

3. The wireless communication method of claim 1, wherein the selected channel access priority class value is the lowest or the highest channel access priority class value in the plurality of channel access priority class values.

4. The wireless communication method of claim 1, wherein the selected channel access priority class value is a default channel access priority class value for a QoS flow corresponding to a non-standardized PC5 QoS identifier (PQI), and
wherein the non-standardized PQI has no corresponding channel access priority class value or is mapped to a default data radio bearer.

5. The wireless communication method of claim 4, wherein the default value is received from a wireless network node or preconfigured.

6. A wireless terminal, comprising:
a processor, configured to:
determine a sidelink channel access priority for a sidelink transmission in an unlicensed carrier based on a channel access priority class value, and
perform a listen-before-talk (LBT) procedure in the unlicensed carrier for the sidelink transmission based on the sidelink channel access priority,
wherein the channel access priority class value is selected from a plurality of channel access priority class values associated with a plurality of quality of service (QOS) files of the sidelink transmission.

7. The wireless terminal of claim 6, wherein the plurality of channel access priority class values is corresponding to a plurality of PC5 QOS identifier (PQI) values or a plurality of packet delay budget values determined for the plurality of QoS files.

8. The wireless terminal of claim 6, wherein the selected channel access priority class value is the lowest or the highest channel access priority class value in the plurality of channel access priority class values.

9. The wireless terminal of claim 6, wherein the selected channel access priority class value is a default channel access priority class value for a QoS flow corresponding to a non-standardized PC5 QoS identifier (PQI), and
wherein the non-standardized PQI has no corresponding channel access priority class value or is mapped to a default data radio bearer.

10. The wireless communication method of claim 9, wherein the default value is received from a wireless network node or preconfigured.

11. A non-transitory computer readable program product comprising a computer-readable program medium code stored thereupon, the code, when executed by at least one processor, causing the at least one processor to implement a wireless communication method comprising:
determining a sidelink channel access priority for a sidelink transmission in an unlicensed carrier based on a channel access priority class value, and
performing a listen-before-talk (LBT) procedure in the unlicensed carrier for the sidelink transmission based on the sidelink channel access priority,
wherein the channel access priority class value is selected from a plurality of channel access priority class values associated with a plurality of quality of service (QOS) files of the sidelink transmission.

12. The non-transitory computer readable program product of claim 11, wherein the plurality of channel access priority class values is corresponding to a plurality of PC5 QOS identifier (PQI) values or a plurality of packet delay budget values determined for the plurality of QoS files.

13. The non-transitory computer readable program product of claim 11, wherein the selected channel access priority class value is the lowest or the highest channel access priority class value in the plurality of channel access priority class values.

14. The non-transitory computer readable program product of claim 11, wherein the selected channel access priority class value is a default channel access priority class value for a QoS flow corresponding to a non-standardized PC5 QOS identifier (PQI), and
wherein the non-standardized PQI has no corresponding channel access priority class value or is mapped to a default data radio bearer.

15. The non-transitory computer readable program product of claim 14, wherein the default value is received from a wireless network node or preconfigured.
